(19) United States
(12) Patent Application Publication
(10) Pub. No.: US 2002/0105111 A1
(43) Pub. Date: Aug. 8, 2002

(54) Apparatus and method of manufacturing seal rings

(76) Inventors: John V. Grabel, Trivoli, IL (US); Kevin D. Hayes, Toccoa, GA (US)

Correspondence Address: Andrew M. Calderon, McGuireWoods, 1750 Tysons Blvd., McLean, VA, 22102-4215, US

(21) Appl. No.: 09/776,797

(22) Filed: Feb. 5, 2001

(51) Int. Cl. B29C 41/04; B29C 33/58

(52) U.S. Cl. 264/237; 425/425; 249/115; 425/DIG. 47; 264/310; 264/311; 264/338

(57) ABSTRACT

An apparatus and method of manufacturing seal rings. The apparatus and method ensures that there is no wasted material during the manufacturing process and further ensures that the seal ring is manufactured to exacting standards without the need for any further milling processes. The apparatus and method has a mold which is heated and rotated at a predetermined rotation rate. A molten material is poured into the mold during the rotation thereof. The mold is then cooled and the rotation is decelerated so that the solidified material can be removed therefrom.

### TECHNICAL FIELD

This invention relates generally to an apparatus and method of manufacturing seal rings and, more particularly, to an apparatus and method of centrifugal casting of seal rings.

### BACKGROUND ART

Manufacturing processes for metal-metal seals have evolved through the years so that such engine components can meet ever increasing performance requirements. These manufacturing processes have made the metal-metal seals more reliable and efficient; however, these same manufacturing processes cannot produce components within precise tolerance limits without the use of additional machining processes which are complex and time consuming processes. Also, current manufacturing processes have a tendency to waste material during the manufacturing of the seals thus increasing the manufacturing costs.

By way of example, in order to manufacture seal rings, a green sand or other sand mold must be prepared by an operator. The preparation of this type of mold includes the use of a metal or rubber pattern mold which conforms to the external shape of the seal ring. The pattern is then used to form a sand mold which is made in an open frame or flask such that both the flask and the sand mold are capable of being parted to facilitate removal of the pattern from the sand. In this scenario, the operator must then bore a central “hub” portion in the mold and several “spokes” stemming from the hub portion. The spokes lead to an inner diameter of the hollow profile in the sand mold formed by the pattern.

A molten alloy (typically nickel or ferrous-based alloy) is then poured into the sand mold via the spokes. Depending on the size of the seal ring, upwards of two hundred pounds of alloy may be used. It is noted, however, that much of this material remains within the spokes of the sand mold and does not form any part of the seal ring. This leads to wasted material. Once the molten alloy is harden or solidified, the seal ring is removed from the mold by breaking apart the mold. At this point, the mold is destroyed and cannot be used again without performing the above process.

Once the mold is broken, the material within the spoke portions of the mold is then removed from the seal ring. This material can be melted again, but may become oxidized which will affect the integrity of the seal ring. The removal of the spoke portions also results in the formation of “knobs” throughout the inner diameter of the seal ring which must then be removed by a complex machining and grinding process. It is also recognized that the molded seal ring has to be further machined in order to meet certain tolerance limits.

U.S. Pat. No. 3,899,020 to Sekimoto et al., issued on Aug. 12, 1975, discloses a metal casting mold for a centrifugal casting machine. The mold is a double walled mold made from an inner casting mold member and an outer casting mold member concentrically fixed together using a plastically deformable spacing member. The inner mold member is fixed to the outer mold member and interposed between a pair of end covers. The inner mold member is a sand mold. The use of this mold is expensive, and requires a complex procedure for manufacturing the molded component.

The present invention is directed to overcoming one or more of the problems as set forth above.

### DISCLOSURE OF THE INVENTION

In one aspect of the present invention a centrifugal apparatus for manufacturing seal rings has a chamber having an opening. A rotating table is positioned within the chamber. A plurality of clamps are coupled to the rotating table. A mold is clamped to the rotating table, and a pouring vessel is located exteriorly to the chamber.

In another aspect of the present invention a method of manufacturing a seal ring has the steps of heating a mold and heating a casting material to molten form. The mold is rotated and the molten material is poured into the mold. The mold is cooled and the rotation of the mold is decelerated to remove the solidified material therefrom.

### BRIEF DESCRIPTION OF THE DRAWINGS

FIG. 1 shows a cut-away view of a seal ring manufactured in accordance with the method of the present invention;

FIG. 2 shows a cut-away view of a mold used to manufacture the seal ring in accordance with the method of the present invention;

FIG. 3 shows a diagrammatic view of an apparatus used to manufacture the seal ring in accordance with the method of the present invention; and

FIG. 4 shows a flow diagram depicting the method steps for manufacturing the seal ring.

### BEST MODE FOR CARRYING OUT THE INVENTION

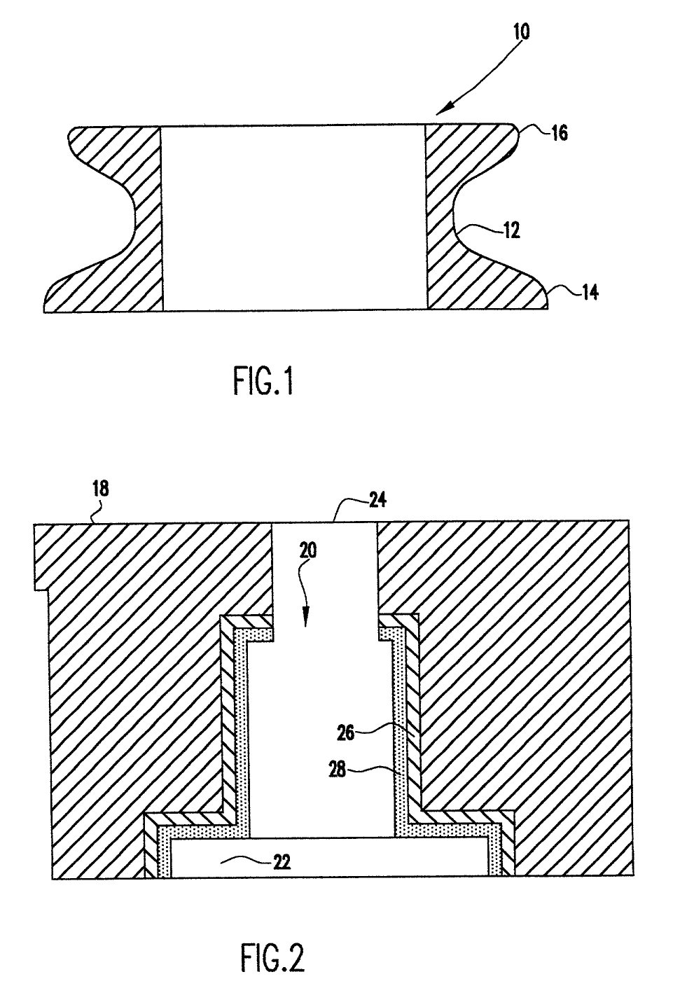

FIG. 1 shows the seal ring manufactured in accordance with the method of the present invention. The seal ring is generally depicted as reference numeral 10 and includes a main body portion 12 having a flange 14 extending therefrom. A lip 16 as well as a draft portion (not shown) may also extend from the main body portion 12. In an embodiment of the seal ring 10, the lip 16 and the draft portion are not necessary to practice the present invention. The seal ring 10 is preferably a nickel or ferrous based alloy material.

FIG. 2 shows a cut-away view of a mold used to manufacture the seal ring in accordance with the method of the present invention. The mold 18 includes a hollow interior profile 20 that corresponds to the shape of the seal ring 10. This interior profile 20 may include at least one groove 22 corresponding to the flange 14 of the seal ring 10; however, other profiles such as a groove corresponding to the lip 16 of the seal ring 10 are also contemplated for use with the mold 18. The mold 18 further includes an opening 24 extending to the hollow interior profile portion 20, and which is preferably positioned at a center and side thereof.

The mold 18 is preferably steel; however, it should be recognized that other materials such as Beryllium/Copper or iron or other appropriate materials may also be used as the mold material. The mold material should have a linear coefficient of contraction which allows proper release of the molded seal ring 10. A coating 26 of preferably Zirconia of less than 1 mm is coated on an interior surface of the mold 18, but other conducting and insulating materials may equally be used as a coating for the mold 18. A mold release 28 may be coated on the coating 26 of the mold 18, which comprises one of Carbon, Boron Nitride or Beryllium/Copper. A powdered form of the mold release material is preferably used with the method of the present invention; however, liquid release has been successfully used.

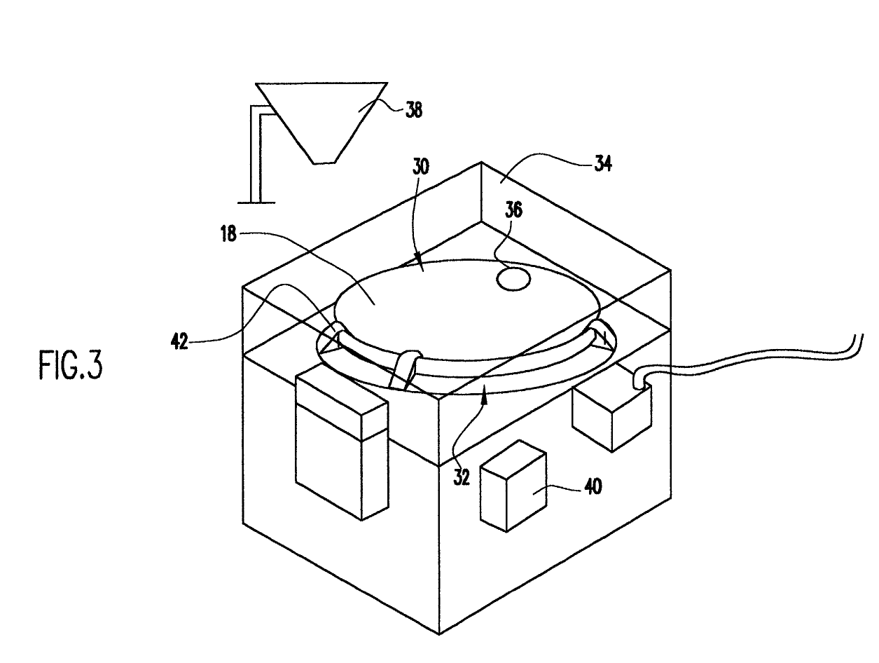

FIG. 3 shows the apparatus used to manufacture the seal ring 10 in accordance with the present invention. In particular, FIG. 3 shows a centrifugal casting apparatus 30 which supports the mold 18 on a drive arrangement 32, e.g., rotating table. The drive arrangement 32 rotates the mold 18 at a predetermined rotation rate. The centrifugal casting apparatus 30 is housed within a chamber 34. An opening 36 is provided in the chamber 34 which is positioned over the opening 24 of the mold 18 during the rotation thereof. A funnel or pouring vessel 38 is positioned on the outside of the chamber 34, proximate to the opening 36. A cooling mechanism 40 may be positioned adjacent the mold 18. A plurality of clamps 42 are provided on the driving arrangement 32.

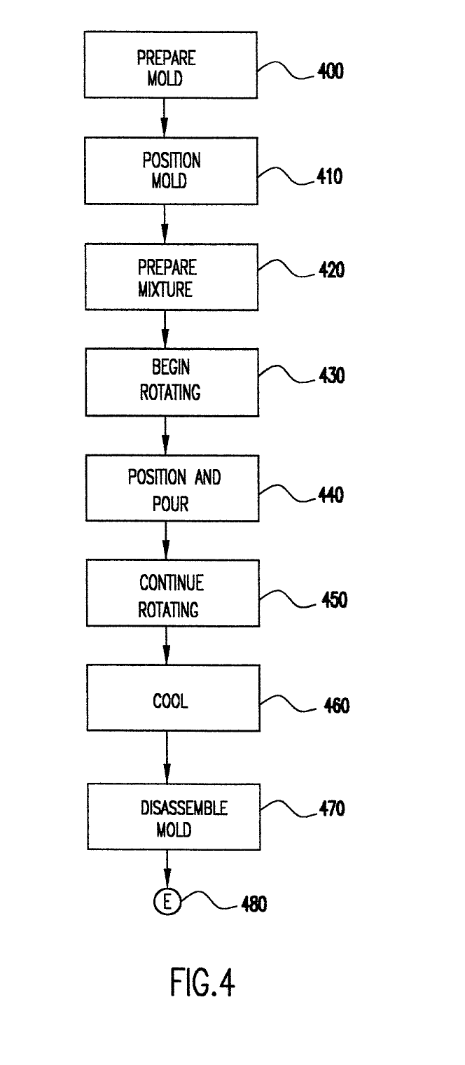

FIG. 4 shows a flow chart of the method of the present invention. In step 400, the mold release material 28 such as, for example, carbon, is coated on the coating 26 of the mold 18. In step 410, the mold 18 is placed on the centrifugal casting apparatus 28 and, more particularly, is clamped to the driving arrangement 32. In this step, the mold 18 may be heated, preferably between approximately 90° C. and 425° C. and may be upwards of 710° C.

In step 420, the alloy mixture used for the casting of the seal ring 10 is then prepared by preferably heating the alloy to between approximately 1370° C. and 1450° C. In step 430, the centrifugal casting apparatus 28 begins to rotate at a predetermined rate, preferably between 500 and 1200 revolutions per minute (RPM). The predetermined rate may vary outside this range depending on variables such as, for example, the particular material used for the mixture as well as the size of the mold and the desired dimensions of the seal ring 10. It should be recognized by those of skill in the art that the order of steps 400-430 are not critical to the method of the present invention, and that these steps may be performed in other sequences as is contemplated by the present invention.

In step 440, the pouring vessel 38 is lowered and begins to pour the molten mixture through the opening 36 and the opening 24. In the preferred embodiment, the chamber 34 includes argon or other protective gases. The pour rate should be approximately 3 lbs./second, but may be other rates depending on the alloy mixture, the speed of rotation of the centrifugal casting apparatus 28 and the like. The pouring of the alloy mixture should preferably be uninterrupted, and should further be in a direction of the rotation of the driving arrangement 32 when such rotation is in the counter-clockwise direction. However, other pouring directions have also been successfully implemented using the present invention.

Once the pouring is complete, the rotation may continue for a predetermined time in step 450. This time is dependent on factors such as the dimensions of the final casting of the seal ring 10. At the end of the predetermined time, the rotation will begin to decelerate, preferably at a rate of 600 RPM or greater. In step 460, the mold is cooled in the range from between approximately 205° C./minute to 1485° C./minute. In step 470, the mold 18 is removed from the centrifugal casting apparatus 28, and the seal ring 10 is removed from the mold 18. The process ends in step 480.

Industrial Applicability

In operation, the mold release material 28 is coated on the interior surface of the mold 18. The mold material 28 does not always have to be coated on the mold 18 due to the use of the coating 26. In use, the mold release 28 should be no thicker than 1 mm. The mold 18 is manufactured within close tolerances to avoid impeding the contraction of the casting when the molten material solidifies. It is further noted that the dimension of the lip 16 of the seal ring 10 is dependent upon the diameter and linear coefficient of contraction of the mold as well as the amount of mold release 28 placed on the interior surface of the mold 18.

The mold 18 is heated and placed on the rotating table 32. Once the mold 18 is placed on the rotating table 32, the mold 18 is then clamped to the rotating table via the clamps 42. Once secured, the mold 18 is rotated and the molten material is poured through the opening 36 of the chamber 34 and through the opening 24 of the mold 18. The pouring of the molten material should be uninterrupted at a rate of approximately 3 lbs./sec.

After the molten material is completely poured into the mold 18, the mold 18 will continue to rotate until the casting is solidified. The deceleration of the mold should be 600 RPM or greater to ensure that he molten material properly solidified in the desired shape. The cooling rate of the mold should be approximately 205° C./minute to 1485° C./minute. This cooling can be accomplished by convection, air or fluid cooling, and is dependent on the particular materials used for the mold 18, the coating 26 and the mold release 28.

By using the apparatus and method of the present invention, the seal ring is capable of being manufactured within very exacting tolerances without the need for further milling process. The seal ring also has a uniform density which adds to the robustness of the seal ring. Additionally, by using the method of the present invention, all of the material poured into the mold is efficiently used, without any wasted material.

Other aspects and features of the present invention can be obtained from a study of the drawings, the disclosure, and the appended claims.

1. A centrifugal apparatus for manufacturing a seal ring, comprising:
a chamber having an opening;
a rotating table positioned within the chamber;
a plurality of clamps coupled to the rotating table;
a mold having an opening corresponding to the chamber opening, the mold being clamped to the rotating table by the plurality of clamps; and
a pouring vessel located exteriorly to the chamber and proximate to the chamber opening.

2. The centrifugal apparatus of claim 1, wherein the mold includes at least one groove corresponding to a flange of the seal ring.

3. The centrifugal apparatus of claim 2, wherein the mold includes at least another groove corresponding to a lip of the seal ring.

4. The centrifugal apparatus of claim 2, wherein the mold includes a coating on an interior surface thereof.

5. The centrifugal apparatus of claim 4, wherein the coating is a conducting or insulating material.

6. The centrifugal apparatus of claim 5, wherein the coating is Zirconia having a thickness of less than 1 mm.

7. The centrifugal apparatus of claim 4, wherein the mold includes a mold release material coated on the coating.

8. The centrifugal apparatus of claim 7, wherein the mold release material includes one of Carbon, Boron Nitride and Beryllium/Copper.

9. The centrifugal apparatus of claim 8, wherein the mold release material is powder.

10. The centrifugal apparatus of claim 1, wherein the mold opening is positioned at a center and side of the mold.

11. The centrifugal apparatus of claim 1, wherein the mold has a linear coefficient of contraction which allows release of the seal ring.

12. The centrifugal apparatus of claim 1, wherein the mold is steel, Beryllium/Copper or iron.

13. A method of manufacturing a seal ring, comprising the steps of:
heating a mold having an interior shape corresponding to an external shape of the seal ring;
heating a casting material to molten form;
rotating the mold at a predetermined rate;
pouring the molten casting material into the mold during the rotating of the mold;
providing a protective gas during the pouring step such that the molten material is exposed to the protective gas;
cooling the molten material in the mold until solidification of the molten material;
decelerating the rotating of the mold after the cooling step and the solidification of the molten material.

14. The method of claim 13, wherein the rotating step includes rotating the mold between a range of approximately 500 and 1200 revolutions per minute.

15. The method of claim 13, including coating the mold with a mold release material prior to the mold heating step.

16. The method of claim 13, including clamping the mold to a centrifugal molding apparatus prior to the rotating step.

17. The method of claim 13, wherein the mold is heated to between approximately 90° C. and 710° C.

18. The method of claim 13, wherein the molten material is heated to between approximately 1370° C. and 1450° C.

19. The method of claim 13, wherein the pouring is performed at a rate of approximately 3 lbs./second.

20. The method of claim 13, wherein the pouring step is uninterrupted and in a direction of the rotation of the mold when the rotation is in a counter-clockwise direction.

21. The method of claim 13, wherein the decelerating step is performed at a deceleration of approximately 600 RPM or greater.

22. The method of claim 13, wherein the cooling step cools the mold in a range from between approximately 205° C./minute to 1485° C./minute.

23. The method of claim 22, wherein the cooling step is performed by one of convection, air and fluids passing over the mold.
